(19) United States
(12) Patent Application Publication
(10) Pub. No.: US 2015/0099167 A1
(43) Pub. Date: Apr. 9, 2015

(54) POSITIVE ELECTRODE FOR LITHIUM-ION SECONDARY BATTERY AND LITHIUM-ION SECONDARY BATTERY

(71) Applicant: KABUSHIKI KAISHA TOYOTA JIDOSHOKKI, Kariya-shi, Aichi (JP)

(72) Inventors: Hiroki Oshima, Kariya-shi (JP); Takeshi Maki, Kariya-shi (JP); Yuki Hasegawa, Kariya-shi (JP)

(73) Assignee: KABUSHIKI KAISHA TOYOTA JIDOSHOKKI, Kariya-shi, Aichi (JP)

(21) Appl. No.: 14/397,228

(22) PCT Filed: Apr. 25, 2013
(86) PCT No.: PCT/JP13/02809

§ 371 Date: Oct. 27, 2014

(30) Foreign Application Priority Data
Apr. 27, 2012 (JP) 2012-102356
Jul. 25, 2012 (JP) 2012-164482
Oct. 12, 2012 (JP) 2012-226699
Dec. 11, 2012 (JP) 2012-269958

(51) Int. Cl. H01M 4/62; H01M 10/0525; H01M 10/0568; H01M 4/505; H01M 4/525

(52) U.S. Cl. CPC H01M 4/628; H01M 4/505; H01M 4/525; H01M 10/0568; H01M 10/0525; H01M 2300/0025; H01M 2220/30; H01M 2220/20
USPC 429/199; 429/212

(57) ABSTRACT

A positive electrode active material layer comprises positive electrode active material particles containing a Li compound or a Li solid solution selected from LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ wherein 0.5≦x≦1.5, 0.1≦a<1, 0.1≦b<1, and 0.1≦c<1, a bonding portion for bonding the positive electrode active material particles with each other and bonding the positive electrode active material particles with a current collector, and an organic coating layer for coating at least part of surfaces of at least the positive electrode active material particles. Having a high strength of bonding with the Li compound, the organic coating layer suppresses direct contact of the positive electrode active material particles and an electrolytic solution even when a lithium-ion secondary battery is used at a high voltage.

### TECHNICAL FIELD

The present invention relates to a positive electrode to be used for a lithium-ion secondary battery and a lithium-ion secondary battery using the positive electrode.

### BACKGROUND ART

Lithium-ion secondary batteries are secondary batteries having high charge and discharge capacity and capable of outputting high power. The lithium-ion secondary batteries are now mainly used as power sources for portable electronic devices and are promising as power sources for electric vehicles to be widely used in future. A lithium-ion secondary battery has an active material capable of absorbing and releasing lithium (Li) at each of a positive electrode and a negative electrode. The lithium-ion secondary battery works by moving lithium ions in an electrolytic solution provided between these two electrodes. In such a lithium-ion secondary battery, lithium-containing metal composite oxide such as lithium-cobalt composite oxide is mainly used as an active material for a positive electrode, and a carbon material having a multilayer structure is mainly used as an active material for a negative electrode.

However, currently available lithium-ion secondary batteries do not have satisfactory capacity, and are demanded to have a higher capacity. As an approach to meet this demand, positive electrode potential to rise a voltage is being studied. However, when used at a high voltage, the lithium-ion secondary batteries have a big problem that battery characteristics drastically deteriorate after repeated charge and discharge. This is supposed to be caused by oxidation decomposition of electrolytic solutions or electrolytes around positive electrodes when the lithium-ion secondary batteries are charged.

That is to say, a decrease in capacity is considered to be caused by consumption of lithium ions by oxidation decomposition of electrolytes around positive electrodes. Moreover, a decrease in output power is considered to be caused because decomposed materials of electrolytic solutions deposit on surfaces of the electrodes or in pores of separators and exhibit resistance to lithium-ion conduction. Therefore, in order to solve these problems, decomposition of the electrolytic solutions or the electrolytes needs to be suppressed.

Japanese Unexamined Patent Application Publication No. H11-097,027, Japanese Unexamined Patent Application Publication (Translation of PCT International Application) No. 2007-510,267 and the like disclose nonaqueous secondary batteries each having a positive electrode having a coating layer comprising an ion-conductive polymer on a surface thereof. Formation of such a coating layer suppresses degradation, such as elution and decomposition, of a positive electrode active material.

These publications, however, do not describe evaluation of the batteries when charged at a high voltage of 4.3 V or more, and it is unclear whether the batteries withstand use at such a high voltage. The coating layers substantially have thicknesses on a micrometer order and exhibit resistance to lithium-ion conduction. Besides, spray coating or one-time dipping is employed as a method for forming these coating layers, and has a difficulty in providing uniform film thickness.

### CITATION LIST

### Patent Literature

[PTL 1] Japanese Unexamined Patent Application Publication No. H11-097,027

[PTL 2] Japanese Unexamined Patent Application Publication (Translation of PCT International Application) No. 2007-510,267

### SUMMARY OF INVENTION

### Technical Problem

The present invention has been made in view of the foregoing circumstances. The object of the present invention is to provide a positive electrode for a lithium-ion secondary battery withstanding use at a high voltage.

### Solution to Problem

A positive electrode for a lithium-ion secondary battery, comprising a current collector and a positive electrode active material layer bonded to the current collector, characterized in that the positive electrode active material layer comprises positive electrode active material particles containing a Li compound or a Li solid solution selected from LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ wherein 0.5≦x≦1.5, 0.1≦a<1, 0.1≦b<1, and 0.1≦c<1, a bonding portion for bonding the positive electrode active material particles with each other and bonding the positive electrode active material particles with the current collector, and an organic coating layer for coating at least part of surfaces of at least the positive electrode active material particles.

### Advantageous Effects of Invention

In the positive electrode for a lithium-ion secondary battery according to the present invention, an organic coating layer is formed on at least part of surfaces of positive electrode active material particles containing a Li compound or a Li solid solution selected from LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ wherein 0.5≦x≦1.5, 0.1≦a<1, 0.1≦b<1, and 0.1≦c<1. Since this organic coating layer coats the positive electrode active material particles, the organic coating layer suppresses direct contact of the positive electrode active material particles and an electrolytic solution even when a resulting lithium-ion secondary battery is used at a high voltage. Moreover, if the organic coating layer has a thickness on a nanometer order to a submicrometer order, the organic coating layer does not exhibit resistance to lithium-ion conduction. Therefore, formation of such an organic coating layer enables to provide a lithium-ion secondary battery suppressing decomposition of an electrolytic solution even when used at a high voltage, having a high capacity and keeping high battery characteristics even after repeated charge and discharge.

Moreover, since the organic coating layer can be formed by dipping, a method for forming the positive electrode of the present invention can employ a roll-to-roll process and improves in productivity.

### BRIEF DESCRIPTION OF DRAWINGS

FIG. 1 is a graph showing a relation between the cycle number and capacity retention rate of lithium-ion secondary batteries produced in Examples 1, 2 and Comparative Example 1.

FIG. 2 is a graph showing a relation between cycle number and capacity retention rate of lithium-ion secondary batteries of Example 3 and Comparative Example 2.

FIG. 3 shows Cole-Cole plots of the lithium-ion secondary batteries of Example 3 and Comparative Example 2 before a cycle test.

FIG. 4 shows Cole-Cole plots of the lithium-ion secondary batteries of Example 3 and Comparative Example 2 before and after the cycle test.

FIG. 5 shows Cole-Cole plots of lithium-ion secondary batteries of Example 9 and Comparative Example 5 before and after a cycle test.

### MODES FOR CARRYING OUT THE INVENTION

A positive electrode for a lithium-ion secondary battery according to the present invention comprises a current collector and a positive electrode active material layer bonded to the current collector. The current collector can be those generally used for positive electrodes for lithium-ion secondary batteries or the like. Examples of the current collector include aluminum foil, aluminum mesh, punching aluminum sheets, aluminum expanded sheets, stainless steel foil, stainless steel mesh, punching stainless steel sheets, stainless steel expanded sheets, foamed nickel, nickel non-woven fabric, copper foil, copper mesh, punching copper sheets, copper expanded sheets, titanium foil, titanium mesh, carbon non-woven fabric, and carbon woven fabric.

When the current collector contains aluminum, forming an electrically conductive layer comprising an electric conductor on a surface of the current collector and then forming the positive electrode active material layer on a surface of the electrically conductive layer is desirable. This structure further improves cycle characteristics of a resulting lithium-ion secondary battery. The reason for this improvement is not clear yet, but it is assumed to be that the electrically conductive layer prevents the current collector from eluding into an electrolytic solution at elevated temperatures. Examples of the electric conductor include carbon such as graphite, hard carbon, acetylene black, and furnace black; and indium tin oxide (ITO) and tin (Sn). The electrically conductive layer can be formed of such an electric conductor by PVD, CVD or the like.

Thickness of the electrically conductive layer is not particularly limited, but preferably the thickness is 5 nm or more. If the thickness is smaller than 5 nm, the effect of improving cycle characteristics is hardly exhibited.

The positive electrode active material layer comprises a number of positive electrode active material particles comprising a positive electrode active material, a bonding portion for bonding the positive electrode active material particles with each other and bonding the positive electrode active material particles with the current collector, and an organic coating layer for coating at least part of surfaces of at least the positive electrode active material particles. The positive electrode active material contains a Li compound or a Li solid solution selected from LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ wherein 0.5≦x≦1.5, 0.1≦a<1, 0.1≦b<1, and 0.1≦c<1. The positive electrode active material can be one of these materials or a mixture of two or more of these materials. When the positive electrode active material is two or more of these materials, the two or more of these materials can form a solid solution. When the positive electrode active material is a three-element-based compound containing all of Ni, Co, and Mn, desirably a+b+c≦1. Of such three-element-based compounds, LiₓNiₐCo_{b}Mn_{c}O₂ is especially preferred. Part of surfaces of these Li compounds or these Li solid solutions can be modified or can be covered with an inorganic compound. In these cases, particles of the Li compounds or the Li solid solutions including the modified surfaces or the covering inorganic compound are called positive electrode active material particles.

Moreover, a different kind of element can be doped in crystal structure of these positive electrode active materials. Although the kind and amount of the element to be doped is not limited, preferred elements are Mg, Zn, Ti, V, Al, Cr, Zr, Sn, Ge, B, As and Si, and a preferred amount falls within a range of 0.01 to 5%.

The bonding portion is a portion formed by drying a binder and bonds the positive electrode active material particles with each other or bonds the positive electrode active material particles with the current collector. Desirably the organic coating layer is also formed on at least part of this bonding portion. In this case, bonding strength can be further increased and a resulting positive electrode active material layer can be prevented from cracking or peeling off even after a severe cycle test at a high temperature and a high voltage.

The organic coating layer can be formed of an organic compound which is solid at least at ordinary temperature, such as a variety of polymers, rubber, oligomers, higher fatty acid, fatty acid ester, and crown ether.

Examples of the polymers to be used in the organic coating layer include cationic polymers such as polyethylene imine, polyallylamine, polyvinylamine, polyaniline, and polydiallyldimethylammonium chloride; and anionic polymers such polyacrylic acid, sodium polyacrylate, poly(methyl methacrylate), polyvinyl sulfonic acid, polyethylene glycol, polyvinylidene fluoride, polytetrafluoroethylene and polyacrylonitrile. Especially preferred are polyvinylidene fluoride, polytetrafluoroethylene, and polyacrylonitrile, which are highly resistant to oxidation; and polyethylene glycol, polyacrylic acid, and poly(methyl methacrylate), which are highly ion conductive.

When polyethylene glycol (PEG) is used, in view of preventing polyethylene glycol from eluting into an electrolytic solution, preferably the polyethylene glycol has a number average molecular weight of 500 or more, further preferably the polyethylene glycol has a number average molecular weight of 2,000 or more and especially desirably has a number average molecular weight of 20,000. Polyethylene glycol (PEG) which has been thermally treated at 50 to 160 deg. C after coating is also preferable to use. Use of thermally treated polyethylene glycol (PEG) further improves battery characteristics. A heat treatment temperature below 50 deg. C is not preferred because heat treatment takes a long time. On the other hand, a heat treatment temperature above 160 deg. C is not preferred, either, because decomposition starts. Heat treatment is desirably carried out in a non-oxidizing atmosphere such as in vacuum, but can be carried out in the air.

Although the organic coating layer can be formed by CVD, PVD, or the like, these methods are not preferred in view of costs. Desirably the organic coating layer is formed by dissolving an organic compound such as a polymer in a solvent and coating a surface with the solution. Coating can be made by using sprayers, rollers, brushes, or the like, but coating by dipping is desired in order to uniformly coat a surface of the positive electrode active material.

If coating is performed by dipping, gaps between the positive electrode active material particles are filled with the organic compound solution, the organic coating layer can be formed on almost entire surfaces of the positive electrode active material particles. Therefore, a resulting organic coating layer securely prevents direct contact of the positive electrode active material and an electrolytic solution.

A coating method by dipping has two choices. First, a slurry containing at least the positive electrode active material and a binder is bonded to a current collector, thereby forming a positive electrode. Then the positive electrode is dipped in the organic compound solution, removed and dried. This operation is repeated, if necessary, and thus an organic coating layer having a predetermined thickness is formed.

The other method is as follows. First, powder of the positive electrode active material is mixed in the organic compound solution, and the mixture is dried by freeze drying or the like. The above operation is repeated, if necessary, and thus an organic coating layer having a predetermined thickness is formed. After that, a positive electrode is formed by using the positive electrode active material having the organic coating layer.

Preferably the organic coating layer has a thickness within a range of 1 to 1,000 nm, and especially desirably within a range of 1 to 100 nm. If the thickness of the organic coating layer is excessively small, the positive electrode active material may directly contact an electrolytic solution. On the other hand, if the thickness of the organic coating layer is on a micrometer order or above, the organic coating layer when used in a secondary battery exhibits great resistance and decreases ion conductivity. Such a thin organic coating layer can be formed by preparing the abovementioned dipping solution (the abovementioned organic compound solution) so as to make the concentration of the organic compound low, and repeating a coating operation. Thus, a thin uniform organic coating layer can be formed.

The organic coating layer only needs to cover at least part of surfaces of the positive electrode active material particles, but in order to prevent direct contact with an electrolytic solution, preferably the organic coating layer covers almost all surfaces of the positive electrode active material particles.

An organic solvent or water can be used as a solvent for dissolving the organic compound. The organic solvent is not particularly limited and can be a mixture of a plurality of kinds of solvents. Examples of the organic solvent include alcohols such as methanol, ethanol and propanol; ketones such as acetone, methyl ethyl ketone and methyl isobutyl ketone; esters such as ethyl acetate and butyl acetate; aromatic hydrocarbons such as benzene and toluene; DMF; N-methyl-2-pyrrolidone; and mixed solvents of N-methyl-2-pyrrolidone and an ester-based solvent (e.g., ethyl acetate, n-butyl acetate, butyl cellosolve acetate, and butyl carbitol acetate) or a glyme-based solvent (e.g., diglyme, triglyme, and tetraglyme).

Preferably the organic compound solution has an organic compound concentration of not less than 0.001 mass % and less than 2.0 mass %, and desirably within a range of 0.1 to 0.5 mass %. If the concentration is too low, probability of contact with the positive electrode active material is low and coating may take a long time. If the concentration is too high, the organic compound may hinder an electrochemical reaction on the positive electrode.

Furthermore, using a cross-linked polymer cross-linking three-dimensionally as a polymer constituting the organic coating layer is also preferred. Examples of the cross-linked polymer include epoxy resin cross-linked with an epoxide group, unsaturated polyester resin cross-linked with styrene, polyurethane resin cross-linked with isocyanate, and phenol resin cross-linked with hexamethylene tetramine. Epoxy resin is preferred.

Among epoxy resin, using a reaction product of an organic compound having at least two glycidyl groups in a molecule thereof and a polymer having a functional group to react to a glycidyl group is also preferred. In this case, the positive electrode active material is more effectively covered and more suppressed from contacting an electrolytic solution. Accordingly, an increase in electric resistance after a cycle test can be suppressed and cyclic characteristics can be further improved.

Examples of the organic compound having at least two glycidyl groups in a molecule thereof include diglycidyl ether, 1,4-butanediol diglycidyl ether, 1,6-hexadiol diglycidyl ether, diglycidyl phthalate, cyclohexane dimethanol diglycidyl ether, ethylene glycol diglycidyl ether, diethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, glycerin diglycidyl ether, hydrogenated bisphenol A glycidyl ether, bisphenol A glycidyl ether, and trimethylol propane triglycidyl ether. Polyethylene glycol glycidyl ether is especially preferred because it has a high lithium ion conductivity.

When a cross-linked polymer cross-linking three-dimensionally is used, preferably the polymer has an aromatic ring in a polymer molecule thereof. Use of a cross-linked polymer having an aromatic ring improves rigidity of a resulting organic coating layer, and therefore improves durability of a resulting lithium-ion secondary battery and improves cycle characteristics.

Accordingly, if a cross-linked polymer cross-linking three-dimensionally with an epoxide group is used and the polymer has an aromatic ring in a molecule thereof, even an organic compound having one glycidyl group allows a resulting lithium-ion secondary battery to exhibit high performance. Examples of the organic compound having one glycidyl group and an aromatic ring in a molecule thereof include phenyl glycidyl ether, p-sec-butyl phenyl glycidyl ether, and p-tert-butyl phenyl glycidyl ether.

Examples of the polymer having a functional group to react to a glycidyl group include polymers having an amino group, an imino group, an amido group, a hydroxyl group, a carboxyl group or the like.

When the organic coating layer is formed by dipping, first a slurry containing at least the positive electrode active material and a binder is bonded to a current collector, thereby forming a positive electrode. Then, the positive electrode is dipped in a mixed solution of two organic compounds to react to each other to be three-dimensionally cross-linked, and then a solvent is removed, thereby forming the organic coating layer. Or the positive electrode is dipped in one of the two kinds of solutions which react to each other to be three-dimensionally cross-linked and then dipped in the other, thereby forming the organic coating layer.

When an organic coating layer comprising, for example, an epoxy resin is formed, the organic coating layer can be formed from a solution in which phenyl glycidyl ether and polyethylene imine are mixed in about equivalent amounts in a solvent. Or the organic coating layer can be formed by dipping the positive electrode alternately in a phenyl glycidyl ether solution and in a polyethylene imine solution. In the latter case, since the positive electrode active material to be used in the positive electrode of the present invention generally has a negative zeta potential, using a cationic polymer having a positive zeta potential such as polyethylene imine first is preferred. In this case, the positive electrode active material and the polymer firmly bond to each other by Coulomb's force, so a total coating layer thickness can be on a nanometer order and a thin uniform organic coating layer can be formed.

When an organic coating layer is formed from the reaction product of the organic compound having at least two glycidyl groups in a molecule thereof and, for example, polyethylene imine, the following method is preferably used. First, the positive electrode is dipped in a solution of polyethylene imine, removed and dried. Then, the positive electrode is dipped in a solution of the organic compound having at least two glycidyl groups in a molecule thereof, removed and heat treated, thereby allowing the organic compound having at least two glycidyl groups in a molecule thereof and polyethylene imine to react to each other. Reaction temperature varies with the kind of organic compound having at least two glycidyl groups in a molecule thereof, but when polyethylene glycol diglycidyl ether is used, the heat treatment can be carried out at 60 to 120 deg. C.

The “zeta potential” mentioned in the present invention is measured by microscopic electrophoresis, rotating diffraction grating, laser Doppler electrophoresis, an ultrasonic vibration potential (WP) method, or an electrokinetic sonic amplitude (ESA) method. Especially preferably, “zeta potential” is measured by laser Doppler electrophoresis. (Specific measurement conditions will be described below but measurement conditions are not limited to those mentioned below. First, solutions (suspensions) each having a solid content concentration of 0.1 wt % were prepared by using DMF, acetone, or water as solvents. Then zeta potential was measured three times at a temperature of 25 deg. C and an average of the measured values was calculated. With respect to the pH, the solutions were put under neutral conditions.)

Having a high strength of bonding with the positive electrode active material, the organic coating layer thus formed suppresses direct contact of the positive electrode active material and an electrolytic solution even when a resulting lithium-ion secondary battery is used at a high voltage. Moreover, if the organic coating layer has a total thickness on a nanometer order, the organic coating layer is suppressed from exhibiting resistance to lithium ion conduction. Therefore, formation of such an organic coating layer enables to provide a lithium-ion secondary battery suppressing decomposition of an electrolytic solution even when used at a high voltage, having a high capacity and keeping high battery characteristics even after repeated charge and discharge.

Using crown ether as an organic compound constituting the organic coating layer is also preferred. Since crown ether has an ethylene oxide unit in a molecule structure thereof, crown ether is believed to contribute to Li ion conduction. Moreover, since an ethylene oxide group is believed to be capable of forming a complex with a transition metal, a transition metal is believed to be suppressed from eluding from the positive electrode active material. Therefore, the use of crown ether enables to provide a lithium-ion secondary battery having a high capacity and keeping high battery characteristics even after repeated charge and discharge.

Examples of crown ether include 12-crown-4-ether, 15-crown-5-ether, 18-crown-6-ether, dibenzo-18-crown-6-ether, and diaza-18-crown-6-ether. Especially 18-crown-6-ether is preferred. Crown thioether can also be used.

Examples of the binder constituting the bonding portion included in the positive electrode active material layer include polyvinylidene difluoride (PVdF), polytetrafluoroethylene (PTFE), styrene-butadiene rubber (SBR), polyimide (PI), polyamide imide (PAI), carboxymethyl cellulose (CMC), polyvinyl chloride (PVC), methacrylic resin (PMA), polyacrylonitrile (PAN), modified polyphenylene oxide (PPO), polyethylene oxide (PEO), polyethylene (PE), and polypropylene (PP). The bonding portion may include, singly or in combination, one or more curing agents such as epoxy resin, melamine resin, blocked polyisocyanate, polyoxazoline, and polycarbodiimide, and/or one or more additives such as ethylene glycol, glycerin, polyether polyol, polyester polyol, acryl oligomer, phthalate esters, dimer acid-modified compounds, and polybutadiene-based compounds, as long as these do not impair characteristics of the positive electrode binder.

Desirably, the organic compound constituting the organic coating layer has a good ability to coat the bonding portion. Accordingly, using an organic compound having a zeta potential of opposite sign to the zeta potential of the binder is preferred. When polyvinylidene fluoride (PVdF), which has a negative zeta potential, is employed as a binder, using a cationic organic compound is preferred.

Besides, a greater difference in potential between the binder and the organic compound is more preferred. Accordingly, when polyvinylidene fluoride (PVdF) is used as a binder, using polyethylene imine (PEI) having a zeta potential of +20 or more for the organic coating layer is preferred.

Also preferably, the positive electrode active material layer contains a conductive additive. The conductive additive is added in order to increase electric conductivity of the electrode. As the conductive additive, carbonaceous particulate such as carbon black, graphite, acetylene black (AB) and vapor grown carbon fiber (VGCF) can be added singly or in combinations of two or more. The amount of the conductive additive is not particularly limited and can be, for example, about 2 to 100 parts by mass with respect to 100 parts by mass of an active material. If the amount of the conductive additive is less than 2 parts by mass, an efficient conductive path cannot be formed. If the amount of the conductive additive exceeds 100 parts by mass, electrode shape formability deteriorates and energy density decreases.

A lithium-ion secondary battery of the present invention comprises the positive electrode of the present invention. The lithium-ion secondary battery of the present invention can employ a known negative electrode and a known electrolytic solution. The negative electrode includes a current collector and a negative electrode active material layer bonded to the current collector. The negative electrode active material layer contains at least a negative electrode active material and a binder, and can contain a conductive additive. Employable as a negative electrode active material is a known material such as graphite, hard carbon, silicon, carbon fiber, tin (Sn) and silicon oxide. Silicon oxide expressed by SiOₓ (0.3≦x≦1.6) can also be used. Each particle of this silicon oxide powder comprises SiOₓ, which is decomposed by disproportionation reaction and comprises fine Si and SiO₂ covering Si. If x is smaller than the lower limit value, the ratio of Si becomes high, so a volume change in charge or discharge becomes too great that cycle characteristics deteriorate. On the other hand, when x exceeds the upper limit value, the ratio of Si becomes low, so energy density descreases. The range of x is preferably 0.5≦x≦1.5, and more desirably 0.7≦x≦1.2.

Almost all SiO is said to be undergo disproportionation to separate into two phases at 800 deg. C or more in an oxygen-free atmosphere. Specifically, application of heat treatment to raw material silicon oxide powder including amorphous SiO powder at 800 to 1,200 deg. C for 1 to 5 hours in an inert atmosphere such as in vacuum and in an inert gas produces powder of silicon oxide containing two phases of amorphous SiO₂ phase and crystal Si phase.

Moreover, a composite of a carbon material and SiO, at a ratio of the carbon material to SiO within a range of 1 to 50 mass % can be used in place of the silicon oxide. Cycle characteristics are improved by compounding the carbon material. When the ratio of the carbon material to SiOₓ is less than 1 mass %, an effect of improving electric conductivity cannot be obtained. When the ratio of the carbon material to SiO exceeds 50 mass %, the ratio of SiOₓ relatively decreases, so negative electrode capacity decreases. Preferably, the ratio of the carbon material to SiOₓ falls within a range of 5 to 30 mass % and more desirably within a range of 5 to 20 mass %. The carbon material can be compounded with SiOₓ by CVD or the like.

Desirably, the silicon oxide powder has an average particle size within a range of 1 to 10 μm. When the average particle size is larger than 10 μm, charge and discharge characteristics of a resulting nonaqueous secondary battery deteriorate. When the average particle size is smaller than 1 μm, the particles aggregate to form coarse particles, and as a result, charge and discharge characteristics of a resulting nonaqueous secondary battery may similarly deteriorate.

The current collector, the binder and the conductive additive of the negative electrode can be similar to those used in the positive electrode active material layer.

A known electrolytic solution and a known separator, which are not particularly limited, are available for the lithium-ion secondary battery of the present invention employing the abovementioned positive electrode and the abovementioned negative electrode. The electrolytic solution is a solution in which lithium salt as an electrolyte is dissolved in an organic solvent. The electrolytic solution is not particularly limited. The organic solvent can be an aprotic organic solvent such as at least one selected from propylene carbonate (PC), ethylene carbonate (EC), dimethyl carbonate (DMC), diethyl carbonate (DEC), ethyl methyl carbonate (EMC), and the like. The electrolyte to be dissolved can be lithium salt which is soluble in an organic solvent, such as LiPF₆, LiBF₄, LiAsF₆, LiI, LiClO₄, and LiCF₃SO₃.

For example, the electrolytic solution can be a solution in which lithium salt such as LiClO₄, LiPF₆, LiBF₄ and LiCF₃SO₃ is dissolved at a concentration of about 0.5 to 1.7 mol/l in an organic solvent such as ethylene carbonate, dimethyl carbonate, propylene carbonate, and diethyl carbonate. Use of LiBF₄ is especially preferred. Simultaneous use of the positive electrode having the organic compound layer and the electrolytic solution containing LiBF₄ produces a synergistic effect of difficulty of decomposing the electrolyte. Therefore, the simultaneous use allows battery characteristics to be kept high even after repeated charge and discharge at a high voltage.

The separator serves to separate the positive electrode and the negative electrode and hold the electrolytic solution, and can be a thin microporous film of polyethylene, polypropylene or the like. Such a thin microporous film can have a heat-resistant layer mainly comprising an inorganic compound. Preferred inorganic compounds are aluminum oxide and titanium oxide.

Shape of the lithium-ion secondary battery of the present invention is not particularly limited and can be selected from a variety of shapes including a cylindrical shape, a multi-layered shape, and a coin shape. Even when the lithium-ion secondary battery of the present invention takes any shape, an electrode assembly is formed by sandwiching the separator with the positive electrode and the negative electrode. Then, the positive electrode current collector and a positive electrode external connection terminal, and the negative electrode current collector and a negative electrode external connection terminal are respectively connected with current collecting leads or the like. Subsequently, this electrode assembly is sealed in a battery casing together with the electrolytic solution, thereby forming a battery.

Hereinafter, the present invention will be described in more detail by way of examples.

### Example 1

### Formation of Positive Electrode

A positive electrode having a positive electrode active material layer was formed by preparing a mixed slurry which contains 88 parts by mass of LiNi_{1/3}Co_{1/3}Mn_{1/3}O₂ as a positive electrode active material, 6 parts by mass of acetylene black (AB) as a conductive additive, and 6 parts by mass of polyvinylidene fluoride (PVdF) as a binder, applying the mixed slurry on a surface of aluminum foil (a current collector) by using a doctor blade, and then drying the slurry coating.

The abovementioned positive electrode was dipped at 25 deg. C for one hour in a solution in which polyethylene glycol (PEG) having a number average molecular weight (Mn) of 2,000 was dissolved in DMF at a concentration of 0.1 mass %, and then removed and air dried. The dipping was performed at 25 deg. C, and no elution of the binder was observed. Moreover, the dipping for one hour was long enough for the polymer solution to fill gaps between particles of the positive electrode active material, and polyethylene glycol (PEG) coated almost all surfaces of the particles of the positive electrode active material. The organic coating layer had a thickness of about 2 nm. The thickness of the organic coating layer was a mean value of measurements at three different points obtained by using a transmission electron microscope (“H9000NAR” produced by Hitachi High-Technologies Corporation) at an accelerating voltage of 200 kV with a magnification of 2,050,000.

### <Formation of Negative Electrode>

A slurry was prepared by mixing 97 parts by mass of graphite, 1 part by mass of furnace black powder as a conductive additive, and 2 parts by mass of a binder comprising a mixture of styrene butadiene rubber (SBR) and carboxymethyl cellulose (CMC). This slurry was applied on a surface of electrolytic copper foil (a current collector) having a thickness of 18 μm by using a doctor blade, thereby forming a negative electrode having a negative electrode active material layer.

### <Production of Lithium-Ion Secondary Battery>

A nonaqueous electrolytic solution was prepared by dissolving LiPF₆ at a concentration of 1 M in a solvent comprising a mixture of ethylene carbonate (EC) and diethyl carbonate (DEC) at a volume ratio of 3:7.

Next, an electrode assembly was produced by sandwiching a microporous polypropylene/polyethylene/polypropylene laminate film having a thickness of 20 μm as a separator with the abovementioned positive electrode and the abovementioned negative electrode. This electrode assembly was wrapped with a polypropylene laminate film and its periphery was heat sealed, thereby forming a film-packed battery. Before a last side was heat sealed, the abovementioned nonaqueous electrolytic solution was introduced into the film casing so as to impregnate the electrode assembly.

### <Test>

First, the lithium-ion secondary battery obtained above was charged at 1 C at a temperature of 25 deg. C, and then discharge capacity at three constant-current (CC) rates of 0.33 C, 1 C and 5 C was measured. Next, the lithium-ion secondary battery was subjected to a cycle test in which one cycle comprised a constant-current, constant-voltage (CCCV) charge at 1 C to 4.5 V at a temperature of 55 deg. C, being kept at that voltage for one hour, rest for 10 minutes, a constant-current (CC) discharge at 1 C to 3.0 V and rest for 10 minutes and was repeated 25 times.

After the cycle test, the lithium-ion secondary battery was again charged at 1 C at a temperature of 25 deg. C and then discharge capacity at three CC rates of 0.33 C, 1 C, 5 C was measured.

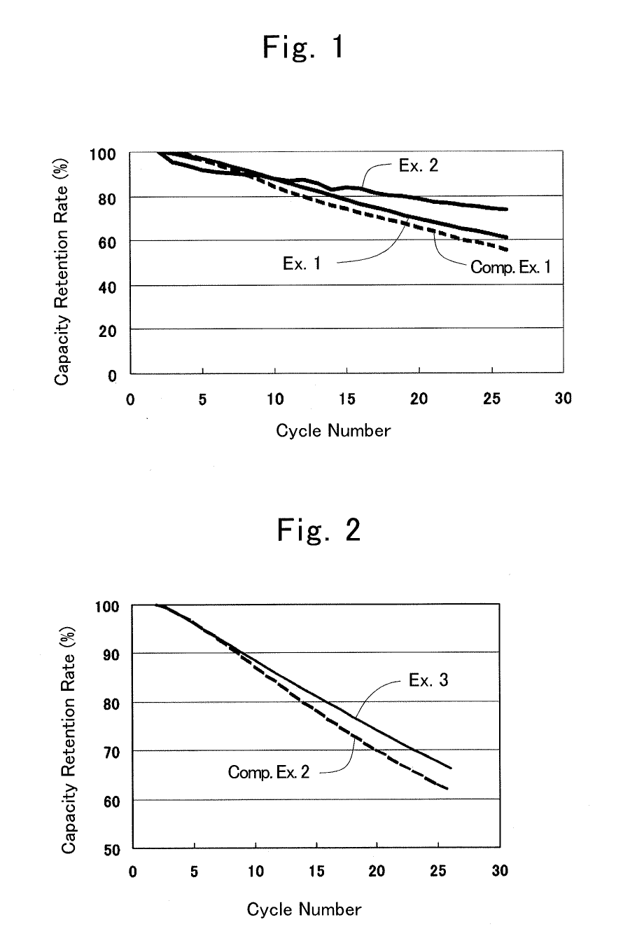

A capacity retention rate, which is a ratio of discharge capacity after the cycle test to discharge capacity before the cycle test, of the lithium-ion secondary battery at each discharge rate at 25 deg. C was calculated. The result is shown in Table 1. Also a relation between the cycle number and capacity retention rate is shown in FIG. 1.

### Example 2

A lithium-ion secondary battery was produced in the same way as in Example 1, except for using a nonaqueous electrolytic solution prepared by dissolving LiBF₄ instead of LiPF₆ as an electrolyte at a concentration of 1 M in a solvent comprising a mixture of ethylene carbonate (EC) and diethyl carbonate (DEC) at a volume ratio of 3:7. A capacity retention rate of the lithium-ion secondary battery at each discharge rate was calculated in the same way as in Example 1. The result is shown in Table 1. Also a relation between cycle number and capacity retention rate is shown in FIG. 1.

### Comparative Example 1

A lithium-ion secondary battery was produced in the same way as in Example 1, except for using a positive electrode which was similar to the positive electrode of Example 1 but had no organic coating layer. A capacity retention rate of the lithium-ion secondary battery at each discharge rate was calculated in the same way as in Example 1. The result is shown in Table 1. Also a relation between cycle number and capacity retention rate is shown in FIG. 1.

### <Evaluation>

TABLE 1

| | COATING | | | CAPACITY |
|---|---|---|---|---|
| | LAYER | ELECTRO- | RATE | RETENTION RATE |
| | MATERIAL | LYTE | (C) | (%) |
| EX. 1 | PEG | LiPF₆ | 0.33 | 51.7 |
| | (Mn = 2,000) | | 1 | 40.2 |
| | | | 5 | 1.4 |
| EX. 2 | PEG | LiBF₄ | 0.33 | 72.4 |
| | (Mn = 2,000) | | 1 | 64.1 |
| | | | 5 | 13.2 |
| COMP. | NO | LiPF₆ | 0.33 | 41.0 |
| EX. 1 | COATING | | 1 | 26.6 |
| | | | 5 | 0.1 |

As is apparent from FIG. 1 and Table 1, the lithium-ion secondary batteries of the examples had higher capacity retention rates than the lithium-ion secondary battery of Comparative Example 1, despite being charged at a high voltage of 4.5 V. Clearly this effect was brought by forming the organic coating layers.

As is also clear from a comparison between Example 1 and Example 2, use of LiBF₄ as an electrolyte is preferred to use of LiPF₆.

### Example 3

### Formation of Positive Electrode

A positive electrode having a positive electrode active material layer was formed by preparing a mixed slurry which contains 88 parts by mass of LiNi_{1/3}Co_{1/3}Mn_{1/3}O₂ as a positive electrode active material, 6 parts by mass of acetylene black (AB) as a conductive additive, and 6 parts by mass of polyvinylidene fluoride (PVdF) as a binder, applying the mixed slurry on a surface of aluminum foil (a current collector) by using a doctor blade, and then drying the slurry coating.

The abovementioned positive electrode was dipped at 25 deg. C in a solution in which polyacrylonitrile (PAN) (Mw=150,000; produced by Polysciences, Inc.) was dissolved in DMF at a concentration of 0.1 mass % and then removed and air dried. This operation was repeated three times, thereby forming a coating layer. The dipping was performed at 25 deg. C, and no elution of the binder was observed.

A lithium-ion secondary battery was produced in the same way as in Example 1, except for using this positive electrode. A capacity retention rate of the lithium-ion secondary battery at each discharge rate was calculated in the same way as in Example 1. The result is shown in Table 2. Also a relation between cycle number and capacity retention rate is shown in FIG. 2.

### Comparative Example 2

A lithium-ion secondary battery was produced in the same way as in Example 1, except for using a positive electrode which was similar to the positive electrode of Example 3 but had no organic coating layer. A capacity retention rate of the lithium-ion secondary battery at each discharge rate was calculated in the same way as in Example 1. The result is shown in Table 2. Also a relation between cycle number and capacity retention rate is shown in FIG. 2.

### <Evaluation>

TABLE 2

| | COATING | | CAPACITY |
|---|---|---|---|
| | LAYER | RATE | RETENTION RATE |
| | MATERIAL | (C) | (%) |
| EX. 3 | PAN | 0.33 | 52.5 |
| | (Mw = 150,000) | 1 | 42.6 |
| | | 5 | 2.1 |
| COMP. | NO | 0.33 | 44.2 |
| EX. 2 | COATING | 1 | 31.5 |
| | | 5 | 0.8 |

As is apparent from Table 2 and FIG. 2, the lithium-ion secondary battery of Example 3 had a higher capacity retention rate than the lithium-ion secondary battery of Comparative Example 2, despite being charged at a high voltage of 4.5 V. Clearly this effect was brought by forming the organic coating layer.

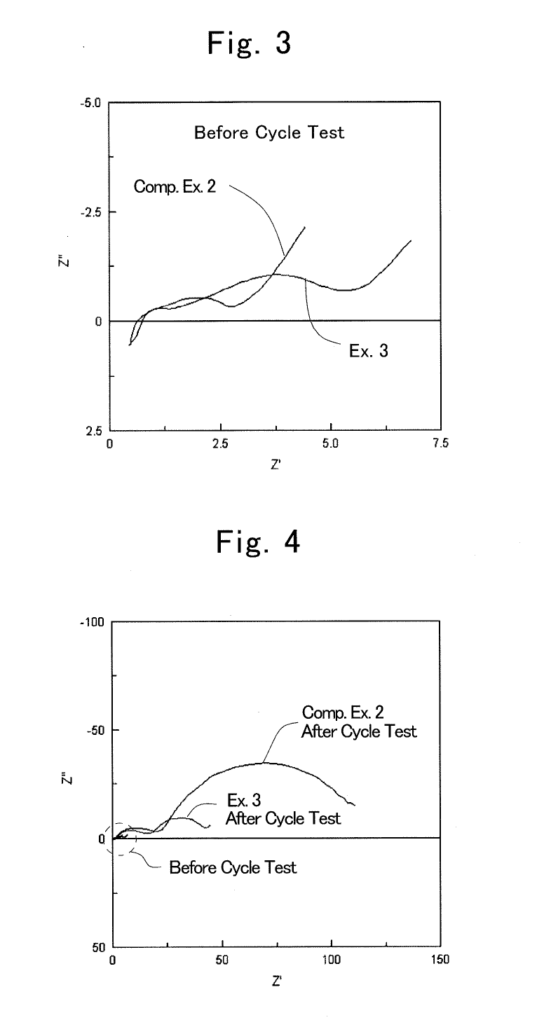

In order to clarify reasons for this, impedance characteristics were evaluated before and after the above cycle test. Specifically, frequency was changed from 0.02 to 1,000,000 Hz at a temperature of 25 deg. C at a voltage of 3.5 V. FIG. 3 shows a Cole-Cole plot before the cycle test, and FIG. 4 shows Cole-Cole plots before and after the cycle test. As is apparent from FIG. 3, a resistance value was slightly increased by forming an organic coating layer. However, as is apparent from FIG. 4, after the cycle test, the lithium-ion secondary battery of Example 3 having an organic coating layer on the positive electrode had a remarkably smaller resistance than the lithium-ion secondary battery of Comparative Example 2 having no organic coating layer. This was caused by a decrease in a resistance body formed by decomposition of the electrolytic solution during the cycle test.

### Example 4

A positive electrode having an organic coating layer was formed in the same way as in Example 3, except for using a solution in which polyethylene imine (PEI, Mw=1,800) instead of polyacrylonitrile (PAN) was dissolved in ethanol at a concentration of 0.1 mass %.

A lithium-ion secondary battery was produced in the same way as in Example 1, except for using this positive electrode. A capacity retention rate of the lithium-ion secondary battery at each discharge rate was calculated in the same way as in Example 1. The result is shown in Table 3.

TABLE 3

| | COATING | | CAPACITY |
|---|---|---|---|
| | LAYER | RATE | RETENTION RATE |
| | MATERIAL | (C) | (%) |
| EX. 4 | PEI | 0.33 | 53.9 |
| | (Mw = 1,800) | 1 | 39.2 |
| | | 5 | 1.5 |

That is to say, clearly formation of an organic coating layer on the positive electrode active material of the present invention suppresses decomposition of an electrolytic solution around the positive electrode even when a resulting lithium-ion secondary battery is used at a high voltage of 4.5 V.

### Example 5

### Formation of Positive Electrode

A positive electrode having a positive electrode active material layer was formed by preparing a mixed slurry which contains 88 parts by mass of LiNi_{1/3}Co_{1/3}Mn_{1/3}O₂ as a positive electrode active material, 6 parts by mass of acetylene black (AB) as a conductive additive, and 6 parts by mass of polyvinylidene fluoride (PVdF) as a binder, applying the mixed slurry on a surface of aluminum foil (a current collector) by using a doctor blade, and then drying the slurry coating.

The abovementioned positive electrode was dipped at 25 deg. C in a solution in which polyethylene imine (PEI) which was similar to polyethylene imine (PEI) of Example 4 was dissolved in ethanol at a concentration of 1 mass %, and then removed and air dried. The dipping was performed at 25 deg. C and no elution of the binder was observed. Subsequently, the PEI-coated positive electrode was dipped in a solution in which polyethylene glycol diglycidyl ether (PEG-DGE) was dissolved at a concentration of 0.5 mass % in ethanol, removed, preliminarily dried at 60 deg. C, and then heat treated at 120 deg. C for 3 hours. Thus formed was an organic coating layer comprising polyethylene imine cross-linked with polyethylene glycol diglycidyl ether.

A lithium-ion secondary battery was produced in the same way as in Example 1, except for using this positive electrode. A capacity retention rate of the lithium-ion secondary battery at each discharge rate was calculated in the same way as in Example 1. The result is shown in Table 4 together with the test result of Example 4.

TABLE 4

| | COATING | | CAPACITY |
|---|---|---|---|
| | LAYER | RATE | RETENTION RATE |
| | MATERIAL | (C) | (%) |
| EX. 4 | PEI | 0.33 | 53.9 |
| | (Mw = 1,800) | 1 | 39.2 |
| | | 5 | 1.5 |
| EX. 5 | PEI + | 0.33 | 54.0 |
| | PEG-DGE | 1 | 57.2 |
| | | 5 | 8.8 |

As is clear from Table 4, capacity retention rate is further improved by forming an organic coating layer comprising a reaction product of PEI and PEG-DGE.

Moreover, the lithium-ion secondary batteries of Example 5 and Comparative Example 1 were subjected to a cycle test which was similar to the cycle test of Example 1. After the cycle test, 10-second resistance expressed in the following formula was measured. The results are shown in Table 5.

10-second resistance=a voltage drop in a 0.33 C discharge after a charge to 4.5 V/a current value

TABLE 5

| | COATING | 10-sec. |
|---|---|---|
| | LAYER | RESISTANCE |
| | MATERIAL | (Ω) |
| EX. 5 | PEI + | 121.5 |
| | PEG-DGE | |
| COMP. | NO | 168.9 |
| EX. 1 | COATING | |

As is apparent from Table 5, the lithium-ion secondary battery of Example 5 was suppressed from increasing in resistance during the cycle test when compared with the lithium-ion secondary battery of Comparative Example 1, despite being charged at a high voltage of 4.5 V. This effect was brought by forming an organic coating layer comprising a reaction product of PEI and PEG-DGE.

That is to say, clearly formation of an organic coating layer on the positive electrode active material according to the present invention suppresses decomposition of an electrolytic solution around the positive electrode even when the positive electrode has a charging potential of not less than 4.3 V, say, 4.5 V against a lithium reference electrode.

### Example 6

### Formation of Positive Electrode

A positive electrode having a positive electrode active material layer was formed by preparing a mixed slurry which contains 88 parts by mass of LiNi_{1/3}Co_{1/3}Mn_{1/3}O₂ as a positive electrode active material, 6 parts by mass of acetylene black (AB) as a conductive additive, and 6 parts by mass of polyvinylidene fluoride (PVdF) as a binder, applying the mixed slurry on a surface of aluminum foil (a current collector) by using a doctor blade, and then drying the slurry coating.

The abovementioned positive electrode was dipped at 25 deg. C for 12 hours in a solution in which 18-crown-6-ether (produced by Tokyo Chemical Industry Co., Ltd.) was dissolved in water at a concentration of 1 mass %, and then removed and air dried.

A lithium-ion secondary battery of Example 6 was produced in the same way as in Example 1, except for using this positive electrode.

### <Test>

Capacity retention rates of the lithium-ion secondary batteries of Example 6 and Comparative Example 1 at each discharge rate were calculated in the same way as in Example 1. The results are shown in Table 6.

TABLE 6

| | | | | | CAPACITY | |
|---|---|---|---|---|---|---|
| | COATING | INITIAL CAPACITY | | | RETENTION RATE | |
| | LAYER | (mAh/g) | | | (%) | |
| | MATERIAL | 0.33 C | 1 C | 5 C | 0.33 C | 1 C |
| EX. 6 | CROWN | 178.2 | 172.3 | 152.1 | 56.3 | 44.1 |
| | ETHER | | | | | |
| COMP. | NO | 177.2 | 171.5 | 146.8 | 47.2 | 32.1 |
| EX. 1 | COATING | | | | | |

As is apparent from Table 6, the lithium-ion secondary battery of Example 6 had a higher capacity retention rate than the lithium-ion secondary battery of Comparative Example 1 despite being charged at a high voltage of 4.5 V. Clearly this effect was brought by forming an organic coating layer from crown ether. Moreover, since initial capacity of Example 6 was not decreased from initial capacity of Comparative Example 1, clearly the organic coating layer did not exhibit resistance.

That is to say, clearly formation of an organic coating layer on the positive electrode active material according to the present invention suppresses decomposition of an electrolytic solution around the positive electrode even when a resulting lithium-ion secondary battery is used at a high voltage of 4.5 V.

### Example 7

Aluminum foil (thickness: 20 μm) having a carbon coating layer of 5 μm in thickness on a surface thereof was used as a current collector. A mixed slurry was prepared so as to contain 88 parts by mass of LiNi_{1/3}Co_{1/3}Mn_{1/3}O₂ as a positive electrode active material, 6 parts by mass of acetylene black (AB) as a conductive additive, and 6 parts by mass of polyvinylidene fluoride (PVdF) as a binder. The mixed slurry was applied on a surface of the carbon coating layer by using a doctor blade and then dried, thereby forming a positive electrode active material layer.

Next, the positive electrode obtained above was dipped in 25 deg. C for 10 minutes in a solution in which polyethylene imine (PEI) was dissolved in ethanol at a concentration of 1 mass %, removed and dried in vacuum at 120 deg. C for three hours.

A lithium-ion secondary battery of Example 7 was produced in the same way as in Example 1, except for using this positive electrode.

### Comparative Example 3

A lithium-ion secondary battery of Comparative Example 3 was produced in the same way as in Example 1, using a positive electrode which was similar to the positive electrode of Example 7 but had no organic coating layer.

### <Test>

First, the lithium-ion secondary batteries of Example 7 and Comparative Examples 1, 3 were charged at 1 C at a temperature of 25 deg. C, and then discharge capacity at three CC discharge rates of 0.33 C, 1 C and 5 C was measured.

Next, these lithium-ion secondary batteries were subjected to a cycle test in which one cycle comprised a CC charge at 1 C to 4.5 V at a temperature of 55 deg. C, rest for 10 minutes, a CC discharge at 1 C to 3.0 V and rest for 10 minutes and was repeated 50 times.

After the cycle test, these lithium-ion secondary batteries were again charged at 1 C at a temperature of 25 deg. C and then discharge capacity at three CC rates of 0.33 C, 1 C, 5 C was measured.

A capacity retention rate, which is a ratio of discharge capacity after the cycle test to discharge capacity before the cycle test, of each of the lithium-ion batteries at each discharge rate was calculated. The results are shown in Table 7.

TABLE 7

| | | | CAPACITY (mAh/g) | | | | CAPACITY | |
|---|---|---|---|---|---|---|---|---|
| | COATING OF | ORGANIC | | | AFTER 50 | | RETENTION RATE | |
| | CURRENT | COATING | INITIAL | | CYCLES | | (%) | |
| | COLLECTOR | LAYER | 0.33 C | 1 C | 0.33 C | 1 C | 0.33 C | 1 C |
| EX. 7 | CARBON | PEI | 178.92 | 169.28 | 136.14 | 109.34 | 76.1 | 64.6 |
| COMP. | — | — | 183.95 | 173.78 | 96.18 | 51.35 | 52.3 | 29.5 |
| EX. 1 | | | | | | | | |
| COMP. | CARBON | — | 184.49 | 174.20 | 111.5 | 55.85 | 60.4 | 32.1 |
| EX. 3 | | | | | | | | |

As is apparent from Table 7, capacity retention rate was improved only by using a current collector having a carbon coating layer on a surface thereof, and was further improved by using a current collector having a carbon coating layer on a surface thereof and forming an organic coating layer.

After the cycle test, these batteries were disassembled and surfaces of the positive electrodes were visually inspected. As a result of the inspection, the positive electrode active material layer peeled off and dropped from the current collector in each of Comparative Examples 1 and 3, but no abnormalities were observed in Example 7. That is to say, bonding strength of the positive electrode active material layer in the positive electrode of Example 7 was found out to be higher than those of Comparative Examples 1 and 3. The reason may be that an organic coating layer was formed also on a surface of a bonding portion and reinforced the bonding portion.

### Example 8

### Formation of Positive Electrode

A positive electrode having a positive electrode active material layer was formed by preparing a mixed slurry which contains 94 parts by mass of LiNi_{0.5}Co_{0.2}Mn_{0.3}O₂ as a positive electrode active material, 3 parts by mass of acetylene black (AB) as a conductive additive, and 3 parts by mass of polyvinylidene fluoride (PVdF) as a binder, applying the mixed slurry on a surface of aluminum foil (a current collector) by using a doctor blade, and then drying the slurry coating.

The abovementioned positive electrode was dipped at 25 deg. C for 10 minutes in a solution in which polyethylene imine (PEI) which was similar to polyethylene imine (PEI) of Example 4 was dissolved in ethanol at a concentration of 1 mass %, and then removed and air dried. The dipping was performed at 25 deg. C and no elution of the binder was observed. Subsequently, using a thermostatic chamber, the PEI-coated positive electrode was dipped at a temperature of 60 deg. C for 10 minutes in a solution in which phenyl glycidyl ether (PGE) was dissolved in ethanol at a concentration of 1 mass %. The PEI-PGE coated positive electrode was removed, preliminarily dried at 60 deg. C and then dried in vacuum at 120 deg. C for 12 hours. Thus formed was a three-dimensionally cross-linked organic coating layer obtained by a reaction of polyethylene imine and phenyl glycidyl ether.

### <Formation of Negative Electrode>

A slurry was prepared by mixing 82 parts by mass of synthetic graphite, 8 parts by mass of acetylene black (AB) as a conductive additive, and 10 parts by mass of a binder comprising a mixture of styrene butadiene rubber (SBR) and carboxymethyl cellulose (CMC). This slurry was applied on a surface of electrolytic copper foil (a current collector) having a thickness of 18 μm by using a doctor blade, thereby forming a negative electrode having a negative electrode active material layer on copper foil.

### <Production of Lithium-Ion Secondary Battery>

A nonaqueous electrolytic solution was prepared by dissolving LiPF₆ at a concentration of 1 M in an organic solvent which was a mixture of ethylene carbonate (EC), ethyl methyl carbonate (EMC) and dimethyl carbonate (DMC) at a volume percent of 30:30:40.

Then, an electrode assembly was produced by sandwiching a microporous polypropylene/polyethylene/polypropylene laminate film having a thickness of 20 μm as a separator with the aforementioned positive electrode and the aforementioned negative electrode. This electrode assembly was wrapped with a polypropylene laminate film and its periphery was heat sealed, thereby forming a film-packed battery. Before a last side was heat sealed, the abovementioned nonaqueous electrolytic solution was introduced into the film casing so as to impregnate the electrode assembly.

### Comparative Example 4

A lithium-ion secondary battery of Comparative Example 4 was produced in the same say as in Example 8, using a positive electrode which was similar to the positive electrode of Example 8 but had no organic coating layer.

### <Test>

First, the lithium-ion secondary batteries obtained above were charged at 1 C at a temperature of 25 deg. C and then discharge capacity was measured at a CC discharge rate of 1 C. Then the lithium-ion secondary batteries were subjected to a cycle test in which one cycle comprised a constant-current, constant-voltage (CCCV) charge at 1 C to 4.5 V at a temperature of 25 deg. C, being held at that voltage for one hour, rest for 10 minutes, a constant-current (CC) discharge at 1 C to 2.5 V and rest for 10 minutes and was repeated 100 times.

After the cycle test, the lithium-ion secondary batteries were again charged at 1 C at a temperature of 25 deg. C and then discharge capacity at a CC discharge rate of 1 C was measured. A capacity retention rate, which is a ratio of discharge capacity after the cycle test to discharge capacity before the cycle test at 25 deg. C, of each of the lithium-ion secondary batteries was calculated. The results are shown in Table 8.

TABLE 8

| | | COMP. |
|---|---|---|
| | EX. 8 | EX. 4 |
| CAPACITY RETENTION RATE (%) | 86.0 | 84.7 |

Table 8 shows that capacity retention rate of the lithium-ion secondary battery of Example 8 was higher than capacity retention rate of the lithium-ion secondary battery of Comparative Example 4 by about 1.5%. This is an effect brought by forming a three-dimensionally cross-linked organic coating layer.

Moreover, impedance of the lithium-ion secondary batteries of Example 8 and Comparative Example 4 was measured before and after the cycle test. Regarding measurement conditions, the lithium-ion secondary batteries were held at a constant voltage of 3.31 V for one minute, rested for one minute, and then frequency was changed from 0.02 to 1,000,000 Hz at a temperature of 25 deg. C at a voltage of 20 mV, an absolute value |Z| at 0.1 Hz was used as an impedance value. The results are shown in Table 9.

TABLE 9

0.1 Hz IMPEDANCE (Ω)

| | | COMP. |
|---|---|---|
| | EX. 8 | EX. 4 |
| BEFORE CYCLE TEST | 2.50 | 2.80 |
| AFTER CYCLE TEST | 2.72 | 3.21 |
| INCREASE RATE (%) | 8.80 | 14.64 |

An increase in impedance at 0.1 Hz of the lithium-ion secondary battery of Example 8 from before the cycle test to after the cycle test was suppressed when compared with the increase of the lithium-ion secondary battery of Comparative Example 4. This is also an effect brought by forming the three-dimensionally cross-linked organic coating layer.

### Example 9

### Formation of Positive Electrode

A positive electrode having a positive electrode active material layer was formed by preparing a mixed slurry which contains 88 parts by mass of LiNi_{1/3}Co_{1/3}Mn_{1/3}O₂ as a positive electrode active material, 6 parts by mass of acetylene black (AB) as a conductive additive, and 6 parts by mass of polyvinylidene fluoride (PVdF) as a binder, applying the mixed slurry on a surface of aluminum foil (a current collector) by using a doctor blade, and then drying the slurry coating.

The abovementioned positive electrode was dipped at 25 deg. C for 10 minutes in a solution in which polyethylene imine (PEI) which was similar to polyethylene imine (PEI) of Example 4 was dissolved in ethanol at a concentration of 1 mass %, and then removed and air dried. The dipping was performed at 25 deg. C and no elution of the binder was observed. Subsequently, using a thermostatic chamber, the PEI-coated positive electrode was dipped at a temperature of 60 deg. C for 10 minutes in a solution in which phenyl glycidyl ether (PGE) was dissolved in ethanol at a concentration of 1 mass %. Then the PEI-PGE-coated positive electrode was removed, preliminarily dried at 60 deg. C and then dried in vacuum at 120 deg. C for 12 hours. Thus formed was a three-dimensionally cross-linked organic coating layer obtained by a reaction of polyethylene imine and phenyl glycidyl ether.

### <Formation of Negative Electrode>

A slurry was prepared by mixing 97 parts by mass of graphite, 1 part by mass of furnace black powder as a conductive additive, and 2 parts by mass of a binder comprising a mixture of styrene butadiene rubber (SBR) and carboxymethyl cellulose (CMC). This slurry was applied on a surface of electrolytic copper foil (a current collector) having a thickness of 18 μm by using a doctor blade, thereby forming a negative electrode having a negative electrode active material layer on copper foil.

### <Production of Lithium-Ion Secondary Battery>

A nonaqueous electrolytic solution was prepared by dissolving LiPF₆ at a concentration of 1 M in a solvent which was a mixture of ethylene carbonate (EC) and diethyl carbonate (DEC) at a volume ratio of 3:7.

Then, an electrode assembly was produced by sandwiching a microporous polypropylene/polyethylene/polypropylene laminate film having a thickness of 20 μm as a separator with the aforementioned positive electrode and the aforementioned negative electrode. This electrode assembly was wrapped with a polypropylene laminate film and its periphery was heat sealed, thereby forming a film-packed battery. Before a last side was heat sealed, the abovementioned nonaqueous electrolytic solution was introduced into the film casing so as to impregnate the electrode assembly.

### Comparative Example 5

A lithium-ion secondary battery of Comparative Example 5 was produced in the same way as in Example 9, using a positive electrode which was similar to the positive electrode of Example 9 but had no organic coating layer.

### <Test>

First, the lithium-ion secondary batteries obtained above were charged at 1 C at a temperature of 25 deg. C and then discharge capacity at a CC discharge rate of 1 C was measured. Next, the lithium-ion secondary batteries were subjected to a cycle test in which one cycle comprised a constant-current, constant-voltage (CCCV) charge at 1 C to 4.5 V at a temperature of 25 deg. C, being held at that voltage for one hour, rest for 10 minutes, a constant-current (CC) discharge at 1 C to 2.5 V and rest for 10 minutes, and was repeated 100 times.

After the cycle test, the lithium-ion secondary batteries were again charged at 1 C at a temperature of 25 deg. C and then discharge capacity at a CC discharge rate of 1 C was measured. A capacity retention rate, which is a ratio of discharge capacity after the cycle test to discharge capacity before the cycle test at 25 deg. C, of each of the lithium-ion secondary batteries was calculated. The results are shown in Table 10.

TABLE 10

| | | COMP. |
|---|---|---|
| | EX. 9 | EX. 5 |
| CAPACITY RETENTION RATE (%) | 88.2 | 80.0 |

Table 10 shows that capacity retention rate of the lithium-ion secondary battery of Example 9 was higher than capacity retention rate of the lithium-ion secondary battery of Comparative Example 5 by about 10%. This is an effect brought by forming a three-dimensionally cross-linked organic coating layer.

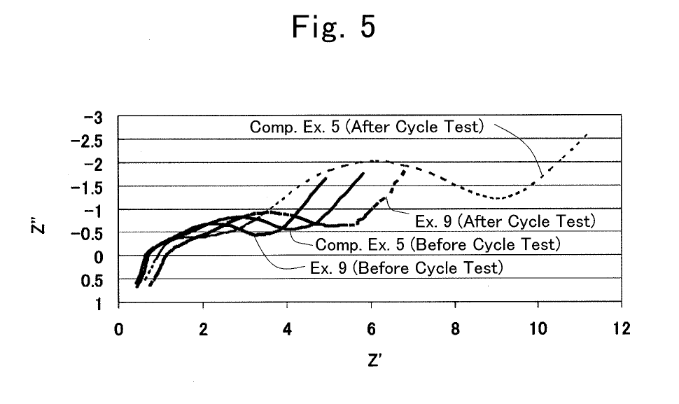

Moreover, impedance of the lithium-ion secondary batteries of Example 9 and Comparative Example 5 was measured before and after the cycle test. Regarding measurement conditions, the lithium-ion secondary batteries were held at a constant voltage of 3.54 V for one minute and rested for one minute, and then frequency was changed from 0.02 to 1,000,000 Hz at a temperature of 25 deg. C at a voltage of 20 mV, and an absolute value |Z| at 0.1 Hz was used as an impedance value. The results are shown in Table 11 and FIG. 5.

TABLE 11

0.1 Hz IMPEDANCE (Ω)

| | | COMP. |
|---|---|---|
| | EX. 9 | EX. 5 |
| BEFORE CYCLE TEST | 4.11 | 4.89 |
| AFTER CYCLE TEST | 5.93 | 9.56 |
| INCREASE RATE (%) | 44.41 | 95.38 |

An increase in impedance at 0.1 Hz of the lithium-ion secondary battery of Example 9 from before the cycle test to after the cycle test was suppressed to less than half when compared with increase in impedance at 0.1 Hz of the lithium-ion secondary battery of Comparative Example 5 from before the cycle test to after the cycle test. This is also an effect brought by forming a three-dimensionally cross-linked organic coating layer.

### INDUSTRIAL APPLICABILITY

The positive electrode for a lithium-ion secondary battery according to the present invention can be used as a positive electrode for a lithium-ion secondary battery to be used to drive motors of electric and hybrid vehicles, or to be used in personal computers, mobile communication equipment, home electric appliances, office equipment, industrial equipment and so on. The lithium-ion secondary battery is particularly suitable to drive motors of electric or hybrid vehicles, which require high capacity and high output power.

1. A positive electrode for a lithium-ion secondary battery, comprising a current collector and a positive electrode active material layer bonded to the current collector, characterized in that
said positive electrode active material layer comprises positive electrode active material particles containing a Li compound or a Li solid solution selected from LiₓNiₐCo_{b}Mn_{c}O₂, LiₓCo_{b}Mn_{c}O₂, LiₓNiₐMn_{c}O₂, LiₓNiₐCo_{b}O₂ and Li₂MnO₃ wherein 0.5≦x≦1.5, 0.1≦a<1, 0.1≦b<1, and 0.1≦c<1, a bonding portion for bonding the positive electrode active material particles with each other and bonding the positive electrode active material particles with the current collector, and an organic coating layer for coating at least part of surfaces of at least the positive electrode active material particles and being formed on at least part of a surface of said bonding portion.

2. The positive electrode for a lithium-ion secondary battery according to claim 1, wherein a charging potential is 4.3 V or more against a lithium reference electrode.

3. The positive electrode for a lithium-ion secondary battery according to claim 1, wherein an electrically conductive layer comprising an electric conductor is formed on a surface of said current collector, and said positive electrode active material layer is formed on a surface of the electrically conductive layer.

4. (canceled)

5. The positive electrode for a lithium-ion secondary battery according to claim 1, wherein said organic coating layer has a thickness of 1 to 1,000 nm.

6. The positive electrode for a lithium-ion secondary battery according to claim 1, wherein said positive electrode active material particles comprise LiₓNiₐCo_{b}Mn_{c}O₂.

7. The positive electrode for a lithium-ion secondary battery according to claim 1, wherein said organic coating layer contains polyethylene glycol having a number average molecular weight of 500 or more.

8. The positive electrode for a lithium-ion secondary battery according to claim 1, wherein said organic coating layer contains polyacrylonitrile.

9. The positive electrode for a lithium-ion secondary battery according to claim 1, wherein said organic coating layer contains a cross-linked polymer cross-linking three-dimensionally.

10. The positive electrode for a lithium-ion secondary battery according to claim 9, wherein said cross-linked polymer contains a reaction product of an organic compound having a glycidyl group in a molecule thereof and a polymer having a functional group to react to a glycidyl group.

11. The positive electrode for a lithium-ion secondary battery according to claim 10, wherein said polymer having the functional group to react to the glycidyl group is polyethylene imine, and said organic compound having the glycidyl group in the molecule thereof is polyethylene glycol diglycidyl ether.

12. The positive electrode for a lithium-ion secondary battery according to claim 10, wherein said cross-linked polymer has an aromatic ring in a molecule thereof.

13. The positive electrode for a lithium-ion secondary battery according to claim 12, wherein said organic compound having the glycidyl group has the aromatic ring in the molecule thereof.

14. The positive electrode for a lithium-ion secondary battery according to claim 13, wherein said organic compound having the aromatic ring in the molecule thereof is phenyl glycidyl ether.

15. The positive electrode for a lithium-ion secondary battery according to claim 1, wherein said organic coating layer contains crown ether.

16. A lithium-ion secondary battery comprising the positive electrode according to claim 1.

17. A lithium-ion secondary battery comprising the positive electrode according to claim 1, a negative electrode, and an electrolytic solution, wherein said electrolytic solution comprises LiBF₄.
